(19) United States
(12) Patent Application Publication
(10) Pub. No.: US 2026/0339957 A1
(43) Pub. Date: Oct. 29, 2026

(54) RETRIEVAL, MODEL-DRIVEN, AND ARTIFICIAL INTELLIGENCE-ENABLED SEARCH

(71) Applicant: HEWLETT PACKARD ENTERPRISE DEVELOPMENT LP, Spring, TX (US)

(72) Inventors: SREENIVAS RANGAN SUKUMAR, Seattle, WA (US); CHRISTOPHER DOUGLAS RICKETT, Spring, TX (US); KRISTYN J. MASCHHOFF, Seattle, WA (US)

(21) Appl. No.: 19/188,625

(22) Filed: Apr. 24, 2025

(51) Int. Cl. G06F 16/2455; G06F 16/22

(52) U.S. Cl. CPC G06F 16/24553; G06F 16/22

(57) ABSTRACT

Systems and methods disclosed herein may include a plurality of operators to search and retrieve various types of data in a result set, simultaneously. For example, a user defined function (UDF) operator can be specified in a query in communication with an interface layer and multiple shards of a database for generating the result set. The execution of UDF operators can be optimized through various redistribution techniques.

### BACKGROUND

The use of large language models (LLMs) or other task-specific Artificial Intelligence/Machine Learning (AI/ML) models as a back-end for AI/ML platforms or mechanisms, such as generative AI applications, chatbots, and the like, has become ubiquitous. Taking LLMs as an example, an LLM may use embeddings, e.g., vector embeddings, to process textual inputs such as a user query, and gain an understanding of the words/phrases as well as relationships between the words/phrases. LLMs may then use this understanding to generate responses to the user query, obtain contextually related data to present in response to user query, etc.

### BRIEF DESCRIPTION OF THE DRAWINGS

The present disclosure, in accordance with one or more various examples, is described in detail with reference to the following figures. The figures are provided for purposes of illustration only and merely depict typical examples.

FIG. 1A illustrates an example intelligent data store system in accordance with various examples.

FIG. 1B illustrates an example of file processing by an Artificial Intelligence (AI) model, and association with a data schema in the example data store system of FIG. 1A.

FIG. 2 illustrates an example intelligent data store system system with compute nodes for processing a search query, in accordance with various examples.

FIG. 3 illustrates an example implementation of an AI model and search query, in accordance with various examples.

FIG. 4 illustrates an example use of a retrieval operator, UDF operator, and AI operator in the intelligent data store system of FIG. 1A for generating a result set, in accordance with various examples.

FIG. 5 illustrates an example implementation of a UDF operator and search query, in accordance with various examples.

FIG. 6 illustrates an example computing component that may be used to process data in response to a query, where the query includes at least one of a query bound UDF or AI model in accordance with various examples.

FIG. 7 illustrates an example query that may be input and received by a front end interface of the system of FIG. 1A.

FIG. 8 illustrates aspects of query planning in accordance with various examples.

FIG. 9 illustrates an example computing component that may be used to optimize queries in accordance with various examples.

FIG. 10 is an example computing component that may be used to implement various features of examples described in the present disclosure.

The figures are not exhaustive and do not limit the present disclosure to the precise form disclosed.

### DETAILED DESCRIPTION

In traditional systems, data is stored separately based on data type, making it difficult to query across multiple data types. This query process across multiple types of data can be time-consuming due to the volume, complexity, and multiple modalities of the data. For example, recent studies suggest there are over 33 exabytes of geo-spatial data in existence (e.g., satellite raster scans, aerial/cosmological images, 3D point clouds, elevation maps and meshes). Various database types attempt to work with large sets of structured, semi-structured, or unstructured data, but rarely do these databases run efficiently or provide search results that accurately find possible data items related to the search query. Thus, LLMs and AI models that leverage such databases and the data stored therein are hamstrung/not able to realize their full potential.

That is, AI models may be trained on huge amounts of data, e.g., on the order of 45 TB of data, and the size of such AI models is commensurately large, e.g., 800 GB. Some AI model providers host endpoints for over 300,000 AI models. Despite this proliferation of AI, however, AI-first or AI-centric databases and turnkey query engines that enable users to leverage AI in queries are nonexistent. More specifically, there are no Structure Query Language (SQL)-like query engines that can: (i) host storage-gravitating unstructured data in conjunction with compute-hungry predictive/generative AI models; (ii) handle and load-balance millions of concurrent queries that leverage a repository of AI models; (iii) search and retrieve by using linear algebraic AI methods on the unstructured data; (iv) allow tagging/filtering/experimentation of stored data by dynamically binding multiple multi-modal AI models at query-time; or (v) deliver performance on query latencies for simultaneous data/insight retrieval and AI model inference.

Systems and methods disclosed herein are directed to an intelligent data store (IDS) system which includes a back-end server and query endpoint. Such an IDS system can be used to automatically shard data, create and maintain indices, as well as orchestrate a query engine with traditional database operators, pre-trained AI models and linear algebraic math libraries for graph theoretic search and retrieval. Moreover, examples of the disclosed technology may include a plurality of operators to search and retrieve various types of data in a result set, simultaneously. The operators may include a retrieval operator, user defined function (UDF) operator, and artificial intelligence (AI) operator in communication with an interface layer and multiple shards of a data structure for generating the result set. In providing this functionality, examples of the disclosed technology allow for massively parallel execution of AI models, query performance optimization and latency minimization, code-porting for cloud-native as-a-serve instantiation, etc. More particularly, AI models can be used to extract searchable features from a dataset(s), which can then be loaded into the IDS, and the ability to use AI models within a search query is provided.

As will be described in greater detail below, an IDS can be a triple store (the term “triple” referring to a unit of information typically structured as a subject-predicate-object statement). In some examples, the IDS may be a triple store that follows the World Wide Web Consortium (W3C) standard of data and metadata representation with Resource Description Framework (RDF), and is query-able using SPARQL Protocol and RDF Query Language (SPARQL). To achieve such functionality, the IDS system is able to create indices of data based on pre-trained AI models (that are hosted as part of the IDS), and allow for the querying of data using query-time bindings to more advanced predictive and generative AI models. In some examples, the data may be represented as or by knowledge graphs, which can be structured representations of data that use a graph-like structure to model entities or objects in conjunction with their relationships. In this way, semantic understanding of the data can be enabled or achieved.

Data may be searched in response to receiving a search query from a user. The search query can request one or more data items of various data types, including structured, semi-structured, or unstructured data. The search query may correspond with a particular query language (e.g., SPARQL query language, etc.). The system can join various sets of data stored in one or more data stores (that make up the IDS) into an interface layer. The interface layer may interact with a retrieval operator, UDF operator, and AI operator to access the data stored with multiple shards of a data store or data structure to determine which of the data satisfy one or more conditions corresponding to each operator. With the retrieval operator, the condition may be associated with the data corresponding to a data attribute of the search query. With the UDF operator, the condition may be associated with the data exceeding a similarity score. The similarity score can be determined by the user or may be a default value. In some examples, the similarity score may represent a probability, ranking, or other similarity value. With the AI operator, the condition may be associated with the data being matched to an attribute of the search query, which uses one or more artificial intelligence models to determine a match. The data that satisfies a condition, exceeds a similarity score, or is returned as a match can be merged into the result set. The result set may take the form of a hash table, vector, key-value index, or feature embeddings that are provided to a user interface. In some examples, the hash table may comprise a data structure for structured and unstructured types of data that can map keys to values. In some examples, the hash table may use a hash function to compute an array that sorts the data results according to data type or other attributes.

Improvements to technology (in addition to those already described above) are provided throughout the present disclosure. For example, improvements can be made to performance and scalability of supercomputer products with general-purpose processors using a high-performance interconnect. Examples may include enhancements to traditional data stores (e.g., graph databases) that can improve the performance of database operations. These operations may enable users to compare terms that are found as part of a search query to apply an order or ranking to the search results. Raw strings for these terms may be stored in a dictionary, which may be implemented as a distributed hash table that spreads the strings across processes. This distribution of the terms results in an increase in efficiency of processing and retrieving different data types simultaneously (e.g., absent multiple queries). Further still, examples of the disclosed technology optimize the use/application of AI models, e.g., reducing operating latencies and resource balancing on a per-AI model basis, as well as across AI models used or bound in a query.

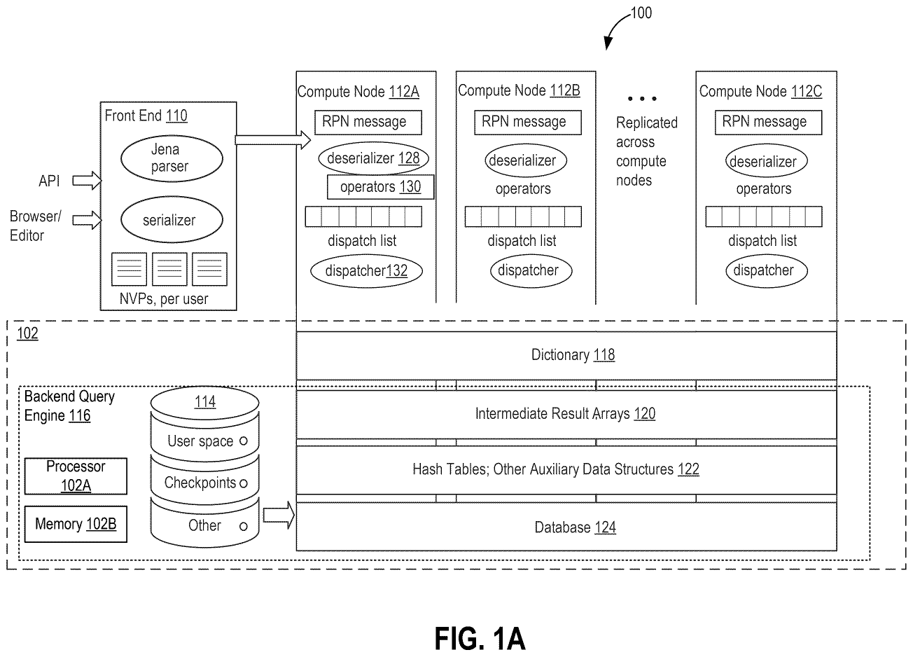

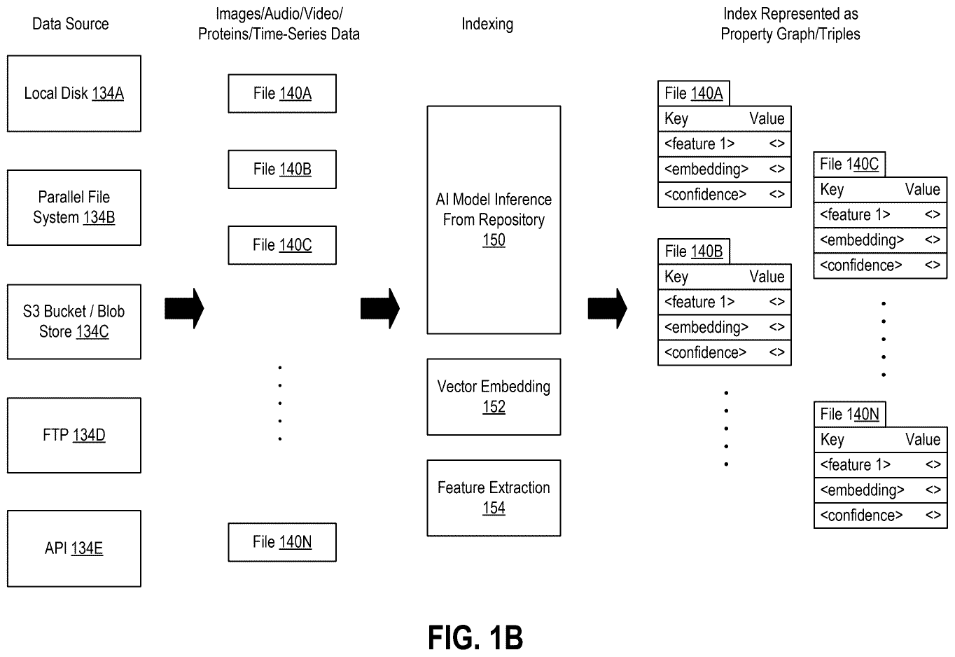

FIG. 1A illustrates an example system, with compute nodes, in accordance with various examples. System 100, an example embodiment of the aforementioned IDS, includes a plurality of resources replicated across multiple compute nodes or images 112 (illustrated as first compute node 112A, second compute node 112B, and third compute node 112C). These resources can include, for example, deserializer 128, operator 130, and dispatcher 132. Access to the plurality of resources may be provided through front end 110.

System 100 may comprise one or more data stores distributed across compute nodes or images 112. For ease of illustration, an example of such one or more data stores, data store 102, is represented. The components of the data stores 102 may comprise, for example, a dictionary 118, intermediate result arrays 120, hash tables and other auxiliary data structures 122, and a database 124. A storage file system 114 can be used to accommodate database 124 as well as user spaces, checkpoints, and other data.

One or more data stores 102 may comprise one or more types of data stores or repositories for storing structured and unstructured data, including an in-memory semantic graph database, although other types of databases may be used without diverting from the scope of the disclosure. One or more data stores 102 may be designed to scale to hundreds of nodes and tens of thousands of processes to support interactive querying of large data sets (~100 s of terabytes). The data stores ingest datasets of N-Triples/N-Quads through various implementations. It should be noted that a quad may extend a triple (described above as a three entity sequence in the form of subject-predicate-object expression) with context or a graph name. For example, ingesting the datasets may be based on a Resource Description Framework (RDF) format and may also accept one or more search queries using the SPARQL query language. The RDF format may be expressed as a labeled, directed graph. The RDF format may correspond with a quad formatting consisting of four fields: subject, predicate, object and graph, or a triple formatting with fewer fields. For example, the following is a simplified version of an example RDF triple that could be loaded into the data stores:
<urn: PODTC2> <urn: mnemonic> “SPIKE_SARS2”

Therefore, and referring now to FIG. 1B, data can be indexed at the time of ingestion at or by the one or more data stores 102 (FIG. 1A) with AI models. The data may be of various types, e.g., images, audio, video, proteins, time-series data, and so on. The data may originate from one or more data sources. Examples of data sources are presented in FIG. 1B, and include, but are not limited to a local disk 134A, a parallel file system 134B, an object container such as a Simple Storage Service (S3) bucket, a data storage system for unstructured data, an example of which is a Binary Large Object (BLOB) store 134C, a File Transfer Protocol (FTP) server 134D, or an Application Programming Interface (API) 134E. The data from such data sources may be stored in and received from a data source in a file format at the one or more data stores 102. As illustrated in FIG. 1B, example files from one or more of data sources 130-138 are file 140A, file 140B, file 140C, . . . file 140N.

One or more data stores 102 have the ability to store a repository of AI models from which inferences 150 regarding the data from files 140A-140N can be made. One or more data stores 102 may further save vector embeddings 152, where vector embeddings can refer to numerical representations of data/objects that retain the “meaning” of the data, e.g., meanings of words, the meanings of images and other data types, as well as relationships, such as relationships between data points, e.g., time-series data. Vector embeddings are typically used by AI models to process data and find patterns in the data. One or more data stores 102 may further have the ability to add or obtain features that may not necessarily be the result of an AI model inference, or that may be obtained via a vector embedding.

To allow such data to be accessed/searched and processed/retrieved as desired by a user, e.g., a user submitting a query via front end 110 (FIG. 1A), the data can be indexed and represented (as noted above) in the form of, e.g., a knowledge graph (such as a property graph) or triples/quads. As illustrated in FIG. 1B, the files from the one or more data sources 134A-E, e.g., file 140A, can be processed by the AI models, and associated with a structure or schema that allows the data in/of file 140A to be accessed/searched and processed/retrieved. In an example, as illustrated in FIG. 1B, a structure or schema can set forth one or more keys, which have associated values. Those keys, may be, e.g., a feature that was extracted during indexing, via feature extraction 154. Features in this context may comprise one or more characteristics of an object or the data. For example, the data may be related to images of patients' spines, and an extracted feature may be the angle of certain vertebrae in those images. The file structure or schema may include, as a key, the vector embedding of an image, where the vector embedding can be used to find similar images, for example. The file structure or schema may further comprise a confidence score of an inference regarding the image, e.g., a score representative of the confidence of an AI model's prediction that the image/features thereof is indicative of some disease.

Referring back to FIG. 1A, one or more data stores 102 may include a network of possible connections. Vertices or nodes generally refer to entities (e.g., data, people, businesses, etc.) and connections between entities are edges. One or more data stores 102 can be used to identify entities connected to other entities. Generally, local processing can be used to process data around compute node 112. Other tasks may involve evaluating edges/connections on a more holistic basis (e.g., in a whole data store or graph analysis).

One or more data stores 102 may be used to generate a semantic graph by system 100. The semantic graph may include a collection of such triples with subjects and objects representing vertices and predicates representing edges between the vertices. Semantic graph databases differ from relational databases in that the underlying data structure is a graph, rather than a structured set of tables in a data store.

Generation of the semantic graph may be accomplished by a backend query engine that runs across compute nodes 112, with the input being distributed across the compute nodes 112 and each node generating a subset of the semantic graph. The final semantic graph is built by syncing the subsets across the compute nodes 112 to remove duplicates.

In various examples, one or more data stores 102 may include two main components: the dictionary and the backend query engine. Dictionary 118 is responsible for building the data store, which is the process of ingesting raw N-Triples/N-Quads files from a high performance parallel file system (e.g., Lustre® file system) and converting them to the internal representation used by the data stores 102. Dictionary 118 stores the unique RDF strings from the N-Triples/N-Quads and provides a mapping between the unique strings and the integer identifiers used for the quads internally by the query engine. The backend query engine 116 may be implemented to process the search query, update requests, or provide a number of built-in graph algorithms (e.g., measures of centrality, PageRank, or connectivity analysis) that can be applied to query data and help return search results as a result set to the user. It should be understood the backend query engine 116 is not a separate engine, but rather a way to refer to the processing functionality/elements (which includes processor 102A and memory 102B) of the one or more data stores 102 that produce a response to/satisfy a query that may be input through front end 110 via compute nodes 112.

Dictionary 118 may comprise a mapping of RDF strings to integer identifiers and the storage of the internal quads are implemented, for example, using distributed hash tables. Each compute node used by the backend query engine may access or store a subset of the complete hash table. In some examples, compute nodes 112 can access the hash table data held by any of the other compute nodes. During query execution, the intermediate results of each step may be saved in an intermediate results array (IRA), which may be distributed across the compute nodes 112.

Front end 110 of system 100 can receive one or more search queries from a user via an application programming interface (API), browser/editor, or other component to access system 100. Front end 110 provides an interface by which a user can interact with the system such as, for example, by submitting queries and receiving results back from the queries. System 100 may be implemented on hardware that can be built on top of a partitioned global address space which may allow the system to treat independent processes, nodes, and images as their own entity, but can subdivide data and share data across the images using a communication library, which may be different than dictionary 118. The communication library can be used for remote processes to exchange data and coordinate operations. System 100 may be configured to run thousands of compute images 112 in a coordinated manner, where the compute images can be run independently on their own subset and the later synchronized when leveraged for results using the communication library.

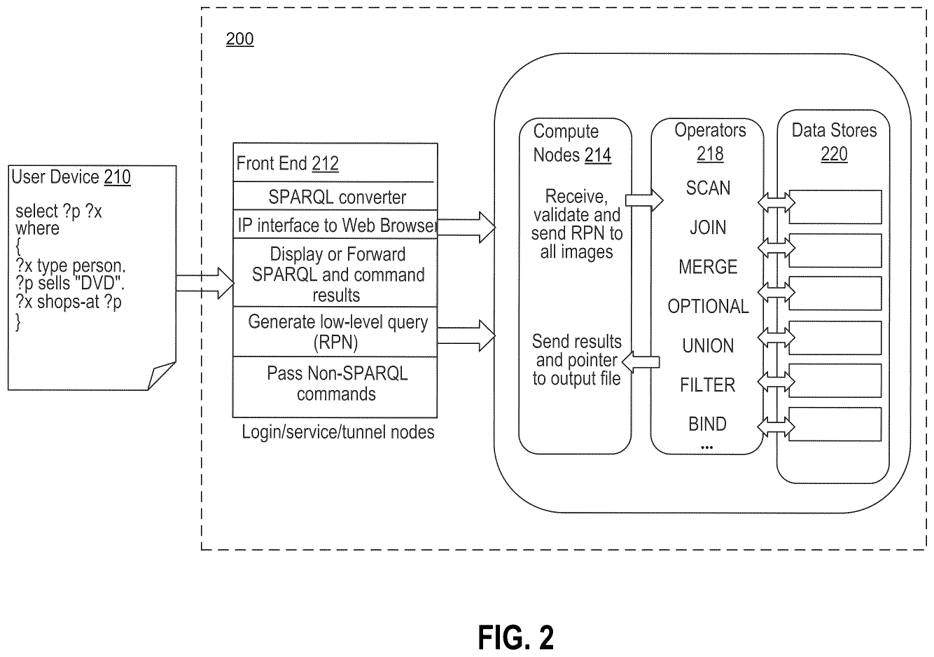

FIG. 2 illustrates an example system with compute nodes for processing the search query, in accordance with various examples. For example, system 200 of FIG. 2 may be an embodiment of system 100 of FIG. 1. Additionally, front end 110, compute node 112, and one or more data stores 102 of FIG. 1A may correspond with front end 212, compute nodes 214, and data stores 220 of FIG. 2.

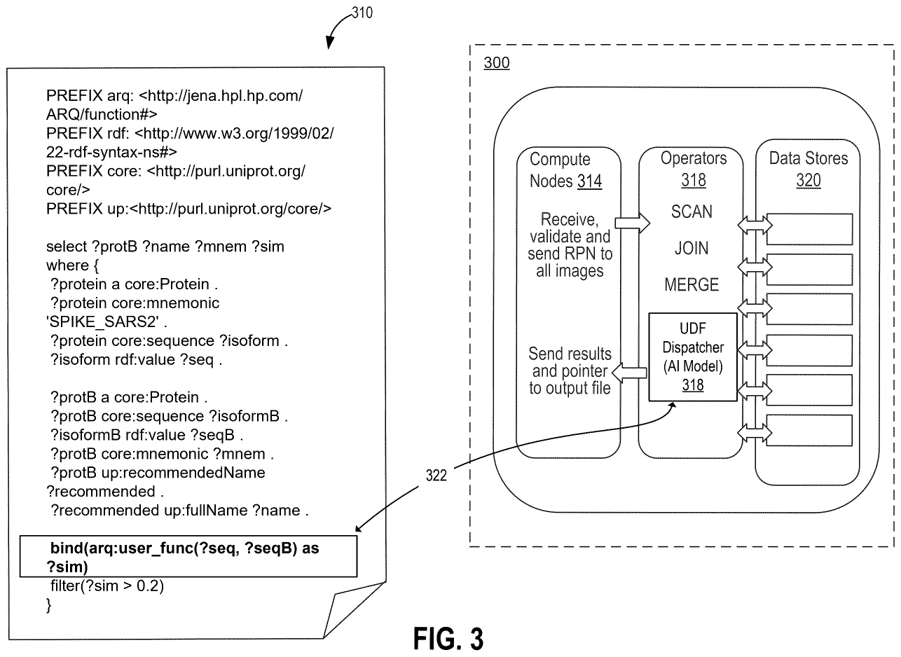

System 200 may receive a search query from user device 210, which can submit the search query through front end 212 implemented as one or more of the interfaces discussed herein. The search query can be converted (e.g., using the SPARQL query language format) by front end 212 and submitted to compute nodes 214, which perform various operations on the data to determine an applicable search result set. In some examples, an interface layer may enable communication and control between front end 212 and the stored data (e.g., separated into shards as illustrated in FIG. 3). Compute nodes 214 can receive the search query and execute one or more operators 218 to perform the query operations on the data items stored in data stores 220. Operators 218 included in this example are SCAN, JOIN, MERGE, OPTIONAL, UNION, FILTER and BIND, although other operations can be used. These operations can be used to traverse the data in various data stores 220 in different ways to fulfill a search query.

FIG. 3 illustrates an example implementation of an AI model and search query, in accordance with various examples. In this illustration, a UDF dispatcher 318 is provided as part of a system 300 (which may the same/similar to system 200 of FIG. 2/system 100 of FIG. 1A), along with compute nodes 314, operators 318, and data stores 320. Other portions of system 300 are removed for simplicity of explanation in this context.

Search query 310 can be submitted to system 300 and operators 318 may determine applicable data from data stores 320, as described herein. In this example, search query 310 includes a request for data associated with a SARS2 spike protein, and the search query includes a mnemonic, which in this example is ‘SPIKE_SARS2’. This portion of search query 310 also identifies a protein sequence for the condition of interest, which in this case is a virus, i.e., a search is to be performed to attempt to identify other proteins with the requisite sequence information.

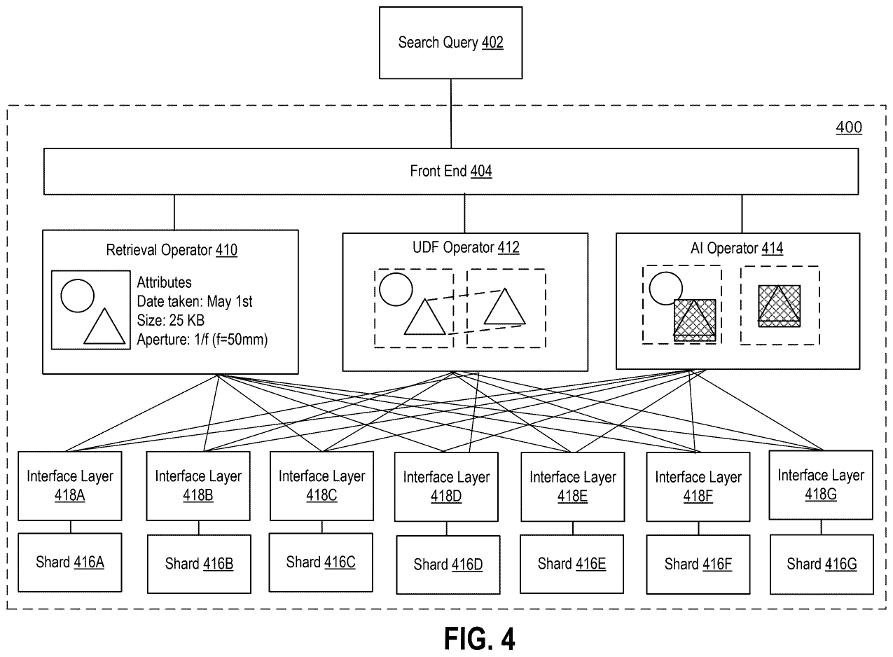

Search query 310 also comprises a bind sequence 322. The bind sequence 322 in search query 310 results in UDF dispatcher 318 joining sets of structured and unstructured data. The data may be provided as a result set (e.g., result set 408 in FIG. 4) and provided to a user interface accessible by user device operated by a user. As described above, a result set may include feature embeddings, vector embeddings, and key-value index embeddings, or other data structure components. Dynamic UDFs, such as UDF dispatcher 318 can be used by the user to, e.g., add new code for utilizing new AI models to execute within a running instance of one or more of data stores 320. Such dynamic UDFs can be used part of data loading/feature extraction, and as part of a query, as described above.

FIG. 4 illustrates an example system with a retrieval operator 410, user defined function (UDF) operator 412, and artificial intelligence (AI) operator 414 in communication with an interface layer and multiple shards of a database for processing the search query, in accordance with various examples. For example, system 400 and front end 404 of FIG. 4 may correspond with system 100 and front end 110 of FIG. 1, respectively.

In this illustration, search query 402 can be submitted from a user device to front end 404 of system 400. An illustrative search query is provided herein:

select distinct ?protB ?sim_orig ?seqB ?seq
where {
?protein a core:Protein ;
core:mnemonic ‘SPIKE_SARS2’ ;
core:sequence ?isoform .
?isoform rdf:value ?seq .
?targetcmpt cco:targetCmptXref ?protB .
?target cco:hasTargetComponent ?targetcmpt .
?assay cco:hasTarget ?target .
?protB a core:Protein ;
core:sequence ?isoformB ;
up:recommendedName ?recommended .
?recommended up:fullName ?name .
?isoformB rdf:value ?seqB .

Front end 404 may pass the attributes of search query 402 across multiple operators, including the retrieval operator 410, UDF operator 412, or the AI operator 414. Using these operators, system 400 can access and analyze a plurality of data sets of various data types simultaneously.

Retrieval operator 410, UDF operator 412, and AI operator 414 can query across a plurality of interface layers 418 (illustrated as first interface layer 418A, second interface layer 418B, third interface layer 418C, fourth interface layer 418D, fifth interface layer 418E, sixth interface layer 418F, and seventh interface layer 418G). Interface layer 418 may be implemented as a hash table, vector embeddings, feature embeddings, key-value index embeddings, or other data structure. Interface layer 418 may comprise the sets of structured and unstructured data returned from shards 416, as described herein.

Shard 416 (illustrated as first shard 416A, second shard 416B, third shard 416C, fourth shard 416D, fifth shard 416E, sixth shard 416F, and seventh shard 416G) may correspond with a partition of a data store, where the data store includes structured or unstructured data. Each data set may comprise a plurality of shards 416, where each shard 416 may correspond with a partition of data in the data store. For data sets, the interface layer may join the sets of data into a hash table or other data structure. This hash table can be queried with a retrieval operator 410, UDF operator 412, and AI operator 414. Retrieval operator 410 can query the semantic graph or data store based on a dictionary search, which determines whether data items comprise a desired attribute or operating characteristic. As an example, a data item may have attributes such as date, size, and aperture. The retrieval operator 410 can determine whether an attribute exists, and return a data item that comprises the requested attributes.

Operators 410, 412, and 414 may query the shards through interface layer 418 to provide search results to the user that span multiple data types. These data types can include graphs, sequences, molecules, video, images, text, and any other data type. Interface layer 418 facilitates providing a single data set to the user in response to search query 402.

Retrieval operator 410 is configured to identify one or more attributes of data items in the data store that would correspond with the attributes requested in search query 402.

UDF operator 412 uses pre-defined or dynamic user-defined functions to generate a comparison between two or more data items. These functions can be written by the user to apply domain specific knowledge to the query result set. A graph database can provide a generic function that users can overwrite with their own function that the graph database can load into memory at program startup. The graph database can define the function in order to enable passing parameters to the user function and allow users to return information to the graph database for the purpose of evaluating an expression for an operator. The information returned to the graph database by the user defined function can enable the domain specific function to rank or filter search results. In various examples, the system can be configured such that the user can add user-defined functions to perform custom searches/queries.

Front end 404, via UDF operator 412, may also be configured to allow generation of custom functions inside query expressions to enable domain-specific operations on data as part of the search query. This is a feature that enables users to define, express, and execute domain-specific mathematical operations to evaluate and rank search results (e.g., when the function is not otherwise supported in the SPARQL query language). Such graph operations can be implemented as custom functions that are defined by the uniform recourse identifier (URI) in expressions. This capability may be configured to enable users to define their own function. An illustrative call to these user-defined functions may comprise, for example:

Prefix arq: <http://jena.hpl.hp.com/ARQ/function#>
...
Arq:sqrt (5)
...

UDF operator 412 can determine the similarity between two data items based on the user-defined functions. This similarity may take the form of a similarity score, which may be applied in response to the search query or based on the relationship between two data items within the data store. The similarity score may be determined based on numerical, geometric, combinatorial, or string-matching algorithms using distributed methods. The UDF operator 412 can set a threshold similarity score that can dictate what data items are returned to the user in response to the search query. As an example, the UDF operator 412 may set a similarity threshold of 0.8. This similarity threshold can be matched or exceeded to return the data item to the user. Using this example, a data item with a similarity score of 0.9 would be returned to the user, while a data item with a similarity score of 0.5 would not exceed that threshold, and thus would not be a part of the search results. The UDF operator 412 can create a set of search results based on the data items that match or exceed the similarity score to return to the user. The UDF operator 412 can create new attributes for data items based on these similarity scores. These new attributes may contribute to future queries through retrieval operator 410 or AI operator 414.

AI operator 414 can use a plurality of AI models to receive one or more data items as input to the AI model, and produce an output. The output is compared with attributes of the search query to determine whether output from the AI model matches the data items. The AI models predict relationships between data items and determine a match based on one or more conditions associated with each model. As an illustrative example, one AI model can determine whether a cat is in an image, while a separate model can determine whether the article discusses illnesses associated with cats. Both of these data items, relating to images and articles, may be considered a match to the search query associated with “cats.”

These matches can also comprise cross-modality predictions such as image-to-text relationships, video-to-image relationships, etc. The use of multiple models by AI operator 414 assists in providing search results that are approximate matches as opposed to only exact matches. These AI models can be pre-trained to determine a search result set from one or more search queries, where the search results include a determined relationship or pattern. AI operator 414 determines whether data items are a match for each applicable AI model and provides any matching data items to front end 404 as part of the search results.

AI operator 414 may also be configured to create new attributes for data items based on the matches or predictions. These new attributes may contribute to future queries through retrieval operator 410 or UDF operator 412 as well.

The search results from each of operators 410, 412, and 414 may be provided to interface layer 418. Interface layer 418 may implement one or more functions on the returned data. As illustrated, interface layer 418 may implement a set of bind functions to scan, join, and merge the data sets of structured and unstructured data into a searchable format at interface layer 418. An illustrative bind function is provided herein.

{
bind(arq:user_func(‘ssw’, ?seq, ?seqB) as ?sim_orig)
filter(?sim_orig >= 0.184)
}
?targetcmpt cco:targetCmptXref ?protB .
?target cco:hasTargetComponent ?targetcmpt .
?assay cco:hasTarget ?target ;
cco:assayType ?assayType .
?protB up:organism ?taxon .
?taxon core:scientificName ?sciName .
{
bind(arq:user_func(‘dtba’, ?smiles, ?seq) as ?dtba)
filter(?dtba >= 6.5)
}
order by desc(?sim_orig) desc(?dtba)

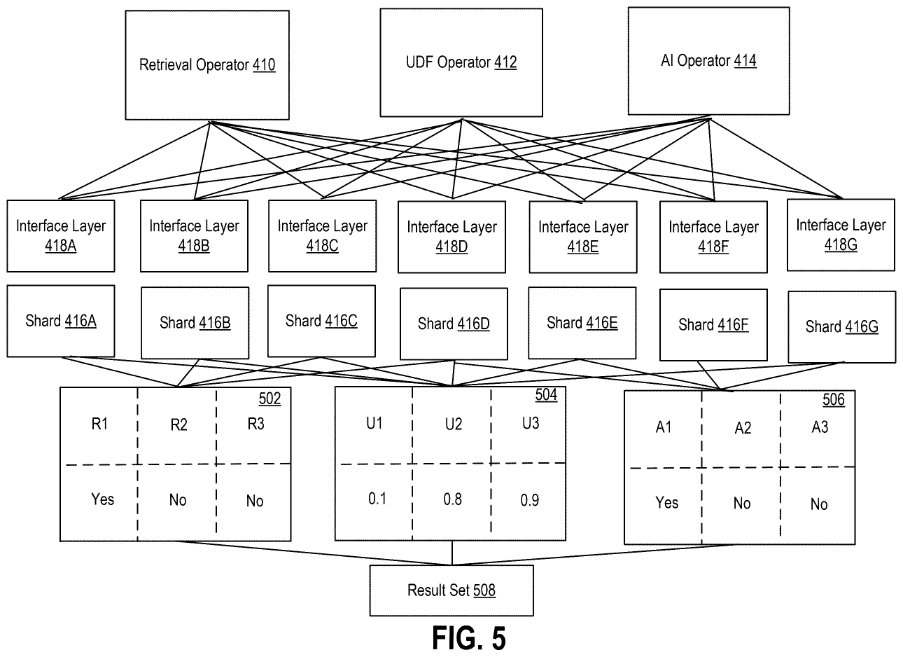

FIG. 4 illustrates an example system with a retrieval operator (410), UDF operator (412), and AI operator (414) in communication with an interface layer and multiple shards of a database for generating the result set, in accordance with various examples. In this example, operators 410, 412, and 414, interface layers 418, and shards 416 of system 400 of FIG. 4 are repeated in FIG. 5 to return result set 508.

In FIG. 5, tables 502, 504, and 506 are also provided to store temporary data. For example, retrieval operator 410 may execute machine readable instructions to generate yes/no determinations. These instructions may determine whether a data item has a particular attribute as described herein. These search results may be stored in a table or dataset 502 to become a part of result set 508. In another example, UDF operator 412 may record similarity scores in a table 504 to be added to result set 508. In another example, AI operator 414 may execute machine readable instructions to generate yes/no determinations. These instructions may determine the output based on the matches received from a plurality of AI models, as described herein. These search results can be stored at table 506 to be returned as a part of result set 508.

Result set 508 may comprise one or more data structures in various formats for storing data tables 502, 504, and 506. Result set 508 can be returned to the user as a single dataset or other predefined formats (e.g., defined by a user profile or other customizable options, to optimize the user experience). In some examples, result set 508 can be stored in a data store of system 400 of FIG. 4, comprising structured and unstructured data, where the data may be returned in response to future search queries.

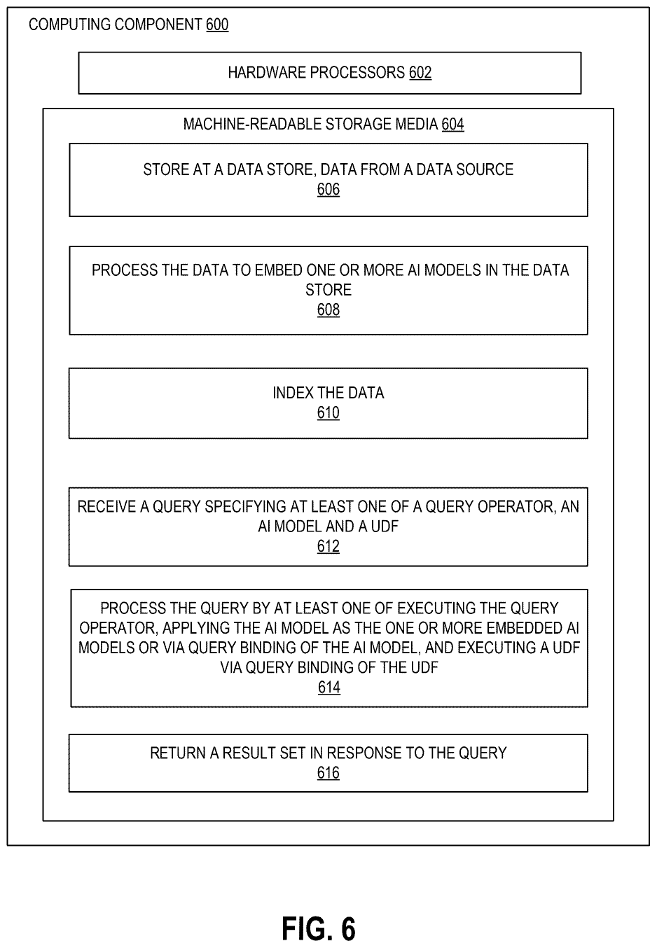

FIG. 6 illustrates an example computing component 600 that may be used to process data in response to a query, where the query includes at least one of a query bound UDF or AI model in accordance with some examples of the disclosed technology. Computing component 600 may be, for example, a server computer, a controller, or any other similar computing component capable of processing data. In the example implementation of FIG. 6, the computing component 600 includes a hardware processor 602, and machine-readable storage medium 604. Hardware processor 602 may be one or more central processing units (CP Us), semiconductor-based microprocessors, and/or other hardware devices suitable for retrieval and execution of instructions stored in machine-readable storage medium 604. Hardware processor 602 may fetch, decode, and execute instructions, such as instructions 606-616, to process data, and respond to a query including at least one of a query bound UDF or AI model. As an alternative or in addition to retrieving and executing instructions, hardware processor 602 may include one or more electronic circuits that include electronic components for performing the functionality of one or more instructions, such as a field programmable gate array (FP GA), application specific integrated circuit (ASIC), or other electronic circuits.

A machine-readable storage medium, such as machine-readable storage medium 604, may be any electronic, magnetic, optical, or other physical storage device that contains or stores executable instructions. Thus, machine-readable storage medium 604 may be, for example, Random Access Memory (RAM), non-volatile RAM (NVRAM), an Electrically Erasable Programmable Read-Only Memory (EEPROM), a storage device, an optical disc, and the like. In some examples, machine-readable storage medium 604 may be a non-transitory storage medium, where the term “non-transitory” does not encompass transitory propagating signals. As described in detail below, machine-readable storage medium 604 may be encoded with executable instructions, for example, instructions 606-618.

Hardware processor 602 may execute instruction 606 to store, at a data store, data from a data source. As described herein, data can originate from a plurality of data sources, including a local disk, a parallel file system, and the like. Queries in conventional data management systems and methods are typically limited to the use of query objects, or when AI models are available for use, AI model-centric processing, where the data is merely the target of a query. AI-model centric processing can refer to processing that is focused on a single model per query, and charging for use on a per-model basis. In AI-model centric processing, AI models can be maintained in some model cache, and accessed via a model API. A typical query may be asking the AI model to determine the existence of a particular subject in an image. Use of that AI model comprises invoking that AI model and applying that AI model every time a user wants that AI model to make a determination, prediction, inference, etc. This can result in serial execution of the AI model, which in turn, can result in delays/increased costs (both from a resource and financial perspective) associated with each execution/subsequent execution of the AI model. In contrast, examples of the disclosed technology can embed AI models in a datastore, making processing a query using AI, more data-centric.

As an example, to analyze a single piece of data, one would typically ping, e.g., 20 AI models, one at a time. To enable a search for a dataset of, e.g., 90,0000 data samples, to be tagged using 100 AI/ML models, a model-centric hosting would entail 90,000*100 API calls to tag the images making up the dataset. Because AI/ML models are typically held/maintained in a compute server, and data is typically stored in a storage server or database, the latency associated with tagging or labeling an entire database is high. Moreover, as noted above, multi-model inferencing is typically performed serially through the use of sequential API calls, again, resulting in high latency/slow performance. Even though performance can be optimized for each AI/ML model, a query involving multiple AI/ML models is typically not the focus of any optimization.

Data-centric query processing, on the other hand, can refer to processing based on multiple models being enabled per query, with the focus (instead of being on the model) being on the data being queried/analyzed. As noted above, in typical systems/methods, the focus of queries are the query objects or AI model(s) that are to be used to query the target, i.e., the data. That is, and as noted above, examples of the disclosed technology enable an IDS and the ability to leverage one or more AI models to respond to a query, where an AI/ML model and data on which the AI/ML model is to be applied can be co-located. As also described herein, AI models can be dynamically invoked in a query via query time binding, as can UDFs, greatly expanding the utility and processing capabilities of data stores configured in accordance with examples of the disclosed technology. Such a data-centric approach can result in optimized performance for each AI/ML model that is invoked, while also optimizing query performance, thereby reducing cost and latency. Further still, in a model-centric system, the provenance and history of already-learned tags (following the above example) is typically lost, where at best, AI/ML model inputs and outputs are tracked. In contrast, the data-centric approach enabled by examples of the disclosed technology allows for a lineage of inferences from an AI/ML model to be maintained closer to the data (where the data is stored). Over time, examples of the disclosed technology can, e.g., collect a complete/holistic view of the data.

Hardware processor 602 may execute instruction 608 to process the data to embed one or more AI models in the data store. In some examples, processing the data to embed the one or more AI models may be accomplished by extracting features/charateristics/objects from the data, vectorizing the data, and applying one or more AI models of an AI model repository to the data to embed the one or more AI models in the data store. As described herein, examples of the disclosed technology provide AI capabilities, but from a data-centric perspective. In some examples, one or more AI models in the data store can be embedded by pre-processing the data from one or more data sources. Pre-processing the data comprises generating a vector embedding representative of the data, and analyzing the data to extract any features or characteristics of or associated with the data, an object comprising the data, etc. Pre-processing may further comprise applying one or more AI models to the data, where any resulting inferences, predictions, etc. become part of the data available to be queried/further analyzed. The embedding of an AI model in this context can refer to the application of an AI model to the data such that the data can be pre-processed to identify relevant data that can be accessed/searched/reference pursuant to a subsequent query. In this way, the AI model, by virtue of being applied prior to the query, has become part of the data.

Hardware processor 602 may execute instruction 610 to index the data. In some examples, indexing the data comprises representing the data in a file structure comprising the extracted features, an inference regarding the data made by the one or more AI models, and a vector embedding resulting from the vectorizing of the data. The extracted features can be stored in a file or data structure, allowing the features to be searched for via a query. In addition to aiding in the processing of the data (as is typically done through the use of vectorized data), the vector embedding can be stored in the file or data structure, again, allowing the data to be searched, e.g., for similarity determinations, via a query. The one or more AI models can also stored as part of the file or data structure, further facilitating the embedding of AI models in the data store.

Hardware processor 602 may execute instruction 612 to receive a query specifying at least one of a query operator, an AI model, and a UDF. As described herein, the query, e.g., a search query, may be associated with one or more sets of structured and unstructured data. These sets of structured and unstructured data may be partitioned into a plurality of shards, as described above (see, e.g. shard 316 of FIG. 3).

Hardware processor 602 may execute instruction 614 to process the query by at least one of executing the query operator, applying the AI model as the one or more embedded AI models or via query binding of the AI model, and executing a UDF via query binding of the UDF. Executing the query operator can proceed in a conventional manner, e.g., executing joins, scans merges, and so on. In some examples, an embedded AI model may be invoked via the query, and as an embedded model, has been applied to the data source data, making any inferences or predictions available to the query. A user may also invoke a non-embedded AI model by using a bind function in the query that allows for the creation of a new function (execution of an AI model) by defining or specifying the AI model in real-time. A UDF can similarly be invoked using a query-time binding.

In operation, for example, the query initiates a search of a plurality of sets of structured and unstructured data by providing the search query to the front end or to the interface layer of the data store as described above. As also described above, this interface layer may provide access to the data stores using a retrieval/query operator, UDF operator, and AI operator (see, e.g. operators 410, 412, and 414). These operators can access the plurality of shards associated with the data stores (e.g., shards 416 of FIG. 4). A search can be performed to determine whether one or more data items within the interface layer satisfies a condition associated with the query operator, e.g., based on a dictionary search, which determines whether data items comprise a desired attribute or operating characteristic. They query operator can determine whether an attribute or feature exists, and return data that comprises the requested attributes. This data can become a part of the result set that can be returned to the user. In some examples described herein, a UDF operator may be used to determine similarity between two data items based on the UDF. The UDF operator can set a threshold similarity score that can dictate what data is returned to the user in response to the search query, as well as create a set of search results based on the data that match or exceed the similarity score to return to the user. A determination can be made as to whether data items are returned as matches from the AI operator. As described above, the AI operator can use one or more AI models to determine whether data items are a match. The models predict relationships between data items and determine a match based on one or more conditions associated with each model. These matches can also comprise cross-modality predictions. The AI operator determines whether data items are a match for each applicable AI model and provides matching data items to the user as part of the result set.

The data that satisfies a condition, exceeds a similarity score, or is returned as matches can be merged into a result set, and hardware processor 602 may execute instruction 616 to return a result set in response to the query. These search results can be stored as a table to be returned to the user device. The result set may comprise a data structure (e.g., hash table) of data received from the retrieval operator, UDF operator, and AI operator. The result set can be stored in the data store of structured and unstructured data to be returned for future queries.

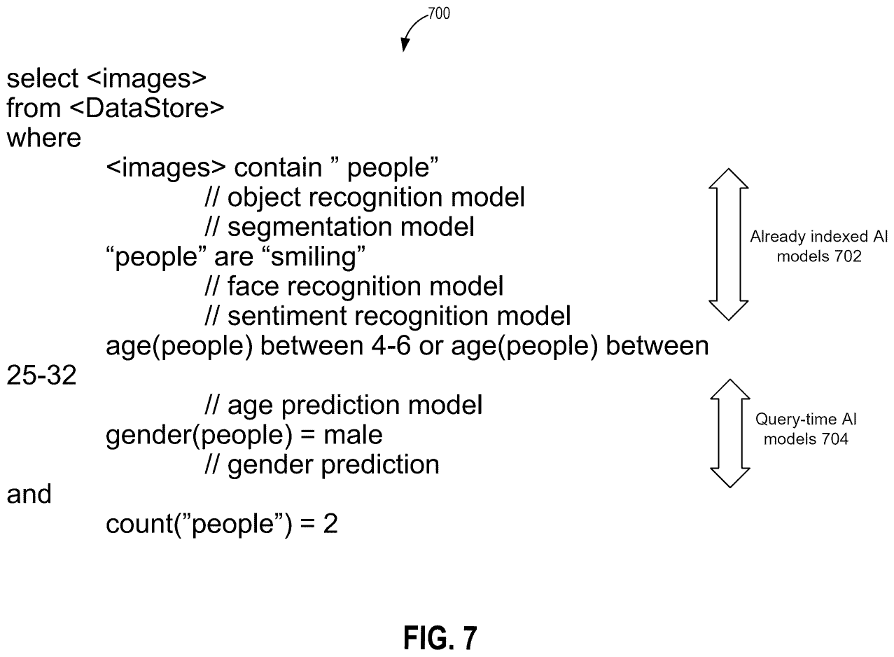

FIG. 7 illustrates an example query 700 that may be input by a user/received by, e.g., front end 110 of system 100 (FIG. 1A). Query 700 comprises an example of a search query that when executed on (applied to) a repository of images, will return results from searching image data using six different computer vision AI models (one each for object recognition, segmentation, face recognition, sentiment recognition, age prediction and gender prediction). Query 700 is expected to return images with two males with a smile, one of them between the ages of 25-32 and another between the ages of 4-6.

In this example, the results of executing the objection recognition model, segmentation model, and face recognition model, are indexed (702) as features when the database is launched. As described above with reference to FIGS. 1A and 1B, examples of the disclosed technology are more data-centric, and may pre-process data or files from one or data sources, and store the data/files in a given file structure or data schema that can be queried. In contrast to these AI models, the age and gender prediction (performed by the age and gender prediction models) can be performed dynamically during query execution, i.e., query-time AI models 704. Query 700, when executed, automatically retrieves/filters only those images with faces in them, and in those segmented images from the pre-processed/indexed index, predicts age and gender. The age and gender AI models are query-time bindings and not database-embedded models. The code below shows an example of dynamic query-time binding (using the bind function) where a user can include a user-defined function using an “arq:user_func” syntax.

```
select distinct ?img ?src
where {
    ?img a <urn://image> ;
    <urn://source> ?src ;
    <urn://contains> ?obj1 ;
    <urn://contains> ?obj2 .
    ?obj1 a “person” .
    <urn://confidence> ?con1 .
  ?obj2 a “person” .
    <urn://confidence> ?con2 .
  bind(arq:user_func(‘age_model’, ?src) as ?age)
  bind(arq:user_func(‘gender_model’, ?src) as ?gender)
  filter(?con > 0.99 && ?age > 20 && ?age < 30 && ?gender == 1)
}
limit 1000
```

It should be understood that the ARQ function code in Jena is code that implements a function in the ARQ engine, which is a JavaScript SPARQL functions library. Thus, an AI model can be called and applied via a query in real-time to underlying data. Again, examples of the disclosed technology are able to integrate AI functionality, and handle queries in a data-centric manner. In some examples, newly query-bound AI models can be embedded, as described above, for future use. That is, when an AI model is invoked by query binding, that AI model can then be stored in the AI model repository of the data store, and in the future, can be applied to data source data during pre-processing of the data to index the data in the data store.

In this way, examples of the disclosed technology not only solve technical problems by the ability to bring new AI models for searching as a production data store, but examples of the disclosed technology effectuate an “experimentation platform” for testing/experimenting with AI models Multiple benefits can be realized. For example, not all object features need to be pre-computed, saving time and data storage space. Some features that may be important to a specific search for one user may not be important in a different context for another user at another time. Thus, respective users can maintain their own feature/content and search context without having to update, bloat, or corrupt a master multi-user database.

Conventional databases or cloud-native solutions only allow for serial AI search calls and filters. Following the above example, a conventional database processing the query would obtain six separate AI inferences in sequence. In contrast, examples of the disclosed technology allow for a single query that comprises multiple AI model search results. As will be described below, examples of the disclosed technology are capable of handling and distributing the execution of multiple AI models in a massively parallel fashion.

Another example is discussed herein, where the query or pseudocode below can be used to create a new drug using AI.

```
Select <drug>
from <DataStore>
where
  <drug> is AI_generated (new_molecule)
    // Molecular GAN model
  <drug> has 3D structure
    // 3D structure prediction model
  <drug> docks with <protein> in 3D
    // 3D-3D alignment model
  <drug> interacts with <protein>
    // Ligand-Protein prediction
  <protein> is like <viral protein = COVID>
    // Protein similarity model
```

In the previous image use-case scenario/example, AI models were used to search for specific features and content (i.e., searching for “what-is” in a database of images). The above query represented as psuedocode is a search for the “what-could-be” with generative AI. The generative AI model (the Molecular Generative Adversarial Network (GAN) model) that is dynamically bound in the query above “generates” a new chemical compound that does not exist in the repository of drug information being searched. Instead, this hypothesized molecule is posed in the context of known scientific data about drugs, proteins, organisms, and clinical trials which are in the data store. The query uses another AI model to render the 3D structure of the new molecule, i.e., the 3D structure prediction model. This 3D structure would then be evaluated using a 3D-3D alignment model for the 3D docking/aligning propensity with the protein structure of the disease-causing organism (which is in the database). Based on the alignment, the query can leverage and connect the dots across, previous clinical trial data, toxicity data etc. to make predictions (using the Ligand-Protein prediction model and the Protein similarity model) on the efficacy and effectiveness of the “new molecule” generated with AI. The query engine will be able to repeat this workflow for, e.g., several thousand “new molecules” in parallel and provide a ranked/prioritized result set.

Searching through an index of features or key-value pairs is typically a linear search problem with well-established retrieval latency patterns (e.g. 2 ms from a storage device). With generative AI models and domain-specific UDFs, not all queries are retrieval functions. Some computations can take seconds, while others take minutes, and inferences or retrieval can take a few milliseconds. Some AI models can process, e.g., 35,000 tokens/second, while other AI models process upwards of, e.g., 750,000 samples/second. As will be described below, examples of the disclosed technology include query planning to balance computations across available resources in an intelligent way. Otherwise, computational resources made available to faster-inferences, for example, would remain idle until the computationally-expensive operations are completed. It should be noted that this query planning functionality can be implemented in one or more compute nodes/data stores of the back-end portion of the IDS, e.g., compute nodes 112/data stores 102 of FIG. 1A.

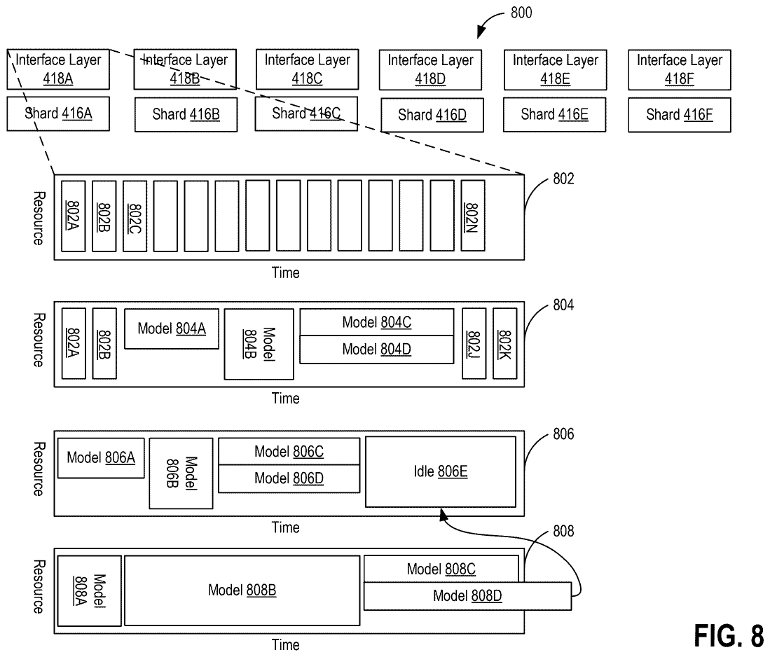

FIG. 8 illustrates aspects of query planning in accordance with examples of the disclosed technology. As described above, interface layers 418A, 418B, 418C, 418D, 418E, and 418F (collectively, interface layer 418) comprise sets of structured and unstructured data returned from shards 416A, 416B, 416C, 416D, 416E, and 416F (collectively, shards 416). Interface layer 418 can join these sets of data into a hash table or other data structure, where the hash table/data structure can then be queried with a query operator, UDF operator, or AI (model) operator).

Examples of the disclosed technology perform query planning in order to optimize compute resources or the operation of compute resources in terms of execution time. Graphs 802, 804, 806, and 808 represent resources, in terms of the availability of flops and memory is represented on the y-axis, while time, i.e., the amount of time or how long a query executes for, is represented on the x-axis. Graph 802 may represent resource usage over time when the query is searching, e.g., a static index of data. As illustrated in FIG. 8, query searching a static index typically involves performing the same, small search operation over and over (in this example, operations 802A, 802B, 802C, . . . 802N.

However, when AI models are dynamically invoked through query binding, such AI models are being invoked in real-time. Moreover, the searches result in the mixing and matching of retrievals that populate a partition/shard with data, along with executions of arbitrarily-sized AI models that may have random resource requirements at a given time, and that may take various amounts of time. Additionally still, not only can the operating characteristics of AI models vary, when dynamically introduced in a query through query binding, there may not be any prior knowledge of those AI models. Thus, AI models are tracked and monitored during use as they are encountered to determine their operating characteristics. It should be noted that an AI model's behavior can also change depending on the data to which the AI model is applied, also introducing unknown aspects of an AI model's operating characteristics.

For example, graph 804 illustrates a scenario wherein a query results in executing a plurality of static index searching operations 802A, 802B, 802J, and 802K. In this scenario, however, a plurality of models are also invoked, e.g., through query binding, models 804A, 804B, 804C, and 804D. In this scenario, model 804A uses some resources over a given amount of time to execute. Relative to model 804B, model 804A uses less compute resources but takes more time to execute. Models 804C and 804D execute over the same amount of time, but each uses less resources than those needed for models 804A and 804B.

In another scenario, as reflected by graph 806, model 806A uses some resources over a given amount of time to execute. Relative to model 806B, model 806A uses less compute resources but takes more time to execute. Models 806C and 806D execute over the same amount of time, but each uses less resources than those needed for models 806A and 806B. Unlike the query model execution sequence represented by graph 804, however, the amount of time needed to execute a query that invokes models 806A-806D takes less time, leaving some amount of idle time 806E during which no resources are being used to execute any query modules. This particular query may, for example, have a query model execution sequence that is less than that associated with another query, in this case, a query whose execution requires resources/time as set forth in graph 808. Accordingly, a query module, in this example, model 808D of graph 808, may be processed using idle resources associated with another query, that whose query model execution sequence is represented by graph 806.

As discussed above, dynamic UDFs can be leveraged by users to add new code, e.g., Python code, which can utilize new AI models, to execute within a running instance of a data store. It should be understood that this new code is not limited to only Python code-any appropriate coding language may be utilized. Such dynamically-added UDFs can be used as part of data loading/feature extraction, and as part of a query. This can be accomplished by defining the code and saving it to a Python file. The following Python code is an example of code that can be executed, e.g., on a local machine or computer, to create a new UDF module that can be imported into a running data store.

```
‘‘‘
udf_mod = ″″″
def str_return(src, lon, box):
  print(f′str_return udf with src={src}, lon={lon}, box={box}′,
    flush=True)
  return f′src={src}, lon={lon}, box={box}′
def int_return(src, lon):
  print(f′int_return udf with src={src}, lon={lon}′, flush=True)
  # Cast the floating point lon to an int to return
  return int(lon)
def float_return(lon):
  print(f′float_return udf with lon={lon}′, flush=True)
      # Cast the floating point lon to a float to return
  return float(lon)
def bool_return(src):
  print(f′bool_return udf with src={src}′, flush=True)
  # Cast the floating point lon to a bool to return
  return (′Chris′ in src)
″″″
file_name = f′{scratch_dir}/my_udfs.py′
f = open(file_name, ′w+′)
f.write(udf_mod)
f.close( )
# Import the module into IDS to use in queries
dsc.import_python(file_name)
‘‘‘
```

It should be noted that this code references the launched data store via a ‘dsc’ variable. The code shows how users can create, e.g., a local Python module with functions the users wish to use inside a query, which could contain code to pull/run AI models, and import them into the data store. Once the functions are imported, they can be used in a query by executing them using a new ‘arq: py_user_func’ operation, such as in the following query:

```
‘‘‘
str_udf_query = ″″″
select distinct ?img ?src ?val
where {
  ?img a <urn://image> ;
  <urn://source> ?src ;
  <urn://contains> ?obj1 ;
  <urn://contains> ?obj2 ;
  <urn://GPSLatitude_DMS> ?lat ;
  <urn://GPSLongitude_DMS> ?lon .
  ?obj1 a ″person″ ;
  <urn://bounding-box> ?box1 ;
  <urn://confidence> ?con1 .
  ?obj2 a ″person″ ;
  <urn://bounding-box> ?box2 ;
  <urn://confidence> ?con2 .
  bind(arq:py_user_func(′my_udfs′, ′str_return′, ?src, ?lon, ?box1) as
  ?val)
  filter(?lat > 39.0 && ?lat < 40.0 && ?lon < −86 && ?lon > −87)
}
″″″
str_udf_results = dsc.query(str_udf_query, verbose=True, trunc=True)
print(str_udf_results)
‘‘‘
```

This query calls the ‘str_return’ function from the newly imported Python module, ‘my_udfs’, that was imported into the running instance of the data store.

With regard to tracking and monitoring the operation of UDFs and AI models, UDFs and AI models are treated the same, the difference being that this operational information is stored in different tables since AI model-related UDFs (and Python UDFs in general) can be dynamically added. The type of information that can be tracked for the AI models/Python UDFs executed as part of queries in the data store include, but is not limited to, e.g., the number of times a UDF is executed, the number of solutions from executing the UDF that are kept, and the amount of time spent executing the UDF. Other information that could potentially be logged includes, e.g., peak memory usage during UDF execution, either for a GPU or CPU. It should be noted that peak memory usage can be used as a basis for ranking a UDF or AI model. Monitoring peak memory usage during UDF execution can be performed using a monitoring thread created by a data store compute process.

It should be noted that a UDF/AI model ranking can refer to a scoring metric associated with the UDF/AI model, such as a peak memory usage value. Another UDF/AI model rank can be a Message Passing Interface (MPI) rank, where an MPI process refers to a parallel computing process, where each parallel process has its own local memory. In other words, this rank can be a parallel process-unique identifier for a given IDS instance. Because an IDS instance (which can comprise multiple compute nodes performing corresponding processes, resulting in massively parallel graph data store engine), there can be hundreds or even thousands of compute processes working together, each having a unique rank.

In order to add new UDFs dynamically (where the new UDFs may use new AI models) system 100 (FIG. 1A) can import user Python code corresponding the query, and store the user Python code in a file directory of data store 102 for a given IDS instance, where the search will be effectuated by the user Python code. The user Python code can comprise a single file, an entire directory, etc. of a user's computing device. If such code has not been loaded before, it can be loaded when executing the UDF as part of the query for the first time. If the code has been loaded before, system 100 can cache the code, and a cached version of the code can be used when executing the UDF. In some examples, users can invoke an API within a query to force system 100 to reload a given module/code instead of using a cached version thereof. This capability allows users to alter their code in a UDF in between queries, often as a result of seeing the output from a previous query, and learning/appreciating that changes may be warranted in order to achieve a desired result/response to the query.

In some examples, query execution can be optimized based on query profiling, i.e., based on the operating characteristics of the UDFs or AI models being query bound, in real-time and during operation of the system. Operations can therefore be rebalanced or redistributed amongst resources over time based on such profiling information. In this way, faster ranks (UDFs/AI models whose operating characteristics are associated with faster processing, e.g., the ability to process more tokens or samples per given time period) can be used to perform more work than slower ranks, thereby bringing down overall compute and query time.

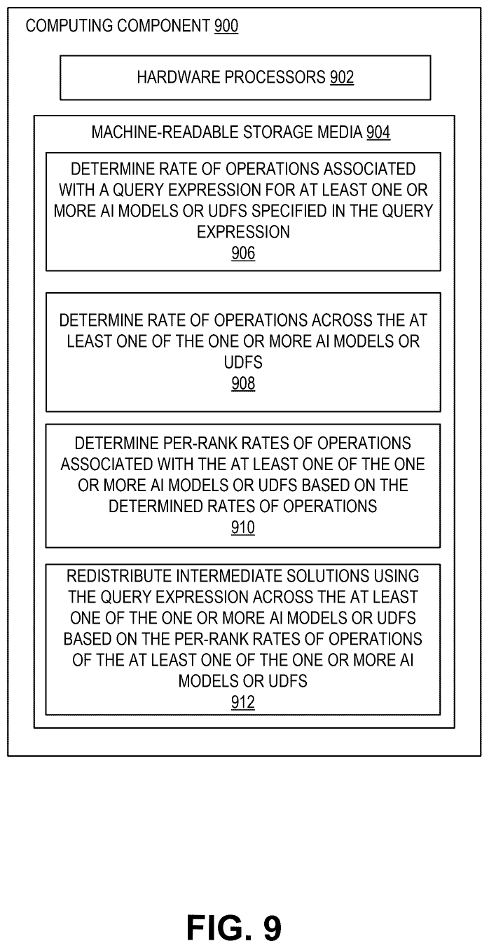

FIG. 9 illustrates an example computing component 900 that may be used to optimize queries in accordance with some examples of the disclosed technology. Computing component 900 (similar to computing component 600) may be, for example, a server computer, a controller, or any other similar computing component capable of processing data. In the example implementation of FIG. 9, the computing component 900 includes a hardware processor 902, and machine-readable storage medium 904. Hardware processor 902 may fetch, decode, and execute instructions, such as instructions 906-912, to optimize queries. As an alternative or in addition to retrieving and executing instructions, hardware processor 902 may include one or more electronic circuits that include electronic components for performing the functionality of one or more instructions, such as a field programmable gate array (FPGA), application specific integrated circuit (ASIC), or other electronic circuits. As described in detail below, machine-readable storage medium 904 may be encoded with executable instructions, for example, instructions 906-912.

Hardware processor 902 may execute instruction 906 to determine a rate of operations associated with a query expression for least one or more AI models or UDFs specified in the query expression. In accordance with some examples, determining a rate of operations comprises computing the average number of AI operations/UDFs performed per second for a given expression set based on times stored in tables for ranks of AI models or UDFs.

Hardware processor 902 may execute instruction 908 to determine a rate of operations across the at least one of the one or more AI models or UDFs. More particularly, in some examples, determining this model-wide rate of operation comprises determining the minimum and maximum number of operations that can be performed per time period, e.g., per second, across the AI model/UDF ranks. For example, the minimum number of operations per second determined by the execution of instruction 908 can be used to create ratios across the UDF/AI model ranks.

Hardware processor 902 may execute instruction 910 to determine per-rank rates of operations associated with the at least one of the one or more AI models or UDFs based on the determined rates of operations. For example, the determined minimum number of operations per second is used to create per-rank rates of operations (number of operations or tokens or samples that can be processed per second). For ease of calculations, in some examples, this per-rank rate of operation can be rounded to a nearest integer. For example, a slowest rank may be determined to be capable of performing 1 operation/min while the fastest rank may be able to process 2 operations/minute. This means that the fastest rank in this example, can do twice the amount of work per second compared to the slowest rank). Rates of operation variations are more likely in heterogeneous environments where nodes may have different CPUs/GP Us, varying amounts of RAM, etc.

Hardware processor 902 may execute instruction 912 to redistribute intermediate solutions using the query expression (a set of one or more operations defined within a filter/order/bind order operation) across the at least one of the one or more AI models or UDFs based on the ranking of the models and UDFs. Redistribution can effectuate optimized performance of the operations that leverage the parallel computing capabilities of compute nodes in accordance with examples of the disclosed technology. An example of such an operation is the below filter operation, which has multiple expressions to evaluate, which include three UDFs (‘ssw,’ ‘pIC50,’, and ‘dtba’). Such UDFs, are a mix of domain-specific computation kernels (ssw, and pIC50), and AI models (DTBA), as well as simpler expression using literals from the query intermediate results (e.g., ?phase>=3). Overall, the filter operation is one operation in the overall query, but the single filter operation has multiple expressions to evaluate,

```
filter(arq:user_func(‘ssw’, ?seq, ?seqB) >= 0.35
  && ?phase >= 3
  && (arq:user_func(‘pIC50’, ?val, ?unit) >= 4.0
    || arq:user_func(‘pIC50’, ?val, ?unit) = 0.0)
  && arq:user_func(‘dtba’, ?smiles, ?seq) >= 6.3)
```

In one example of the disclosed technology, this redistribution may be performed by summing up how many multiples of the slowest rank can be solved per second (i.e., summing up the operations-per-second values across ranks). This value can be divided by the number of intermediate solutions to evaluate. This determination regarding the number of intermediate solutions to be evaluated can be assigned to each rank for each multiple of the slowest rate of operations that the given rank can process. For example, given 1.4 million intermediate solutions to be evaluated, there may be 900 ranks, where 500 ranks have 100 multiples that can be solved/second, 300 ranks have 200 multiples that can be solved/second, and 100 ranks have 300 multiples that can be solved/second. The slowest rank can compute 100 multiples/second, the fastest rank can do 300 computations/second, or 3× the slowest. The total number of chunks to split input into is as follows: −500+(300*2)+(100*3)=1400, where 1.4M/1.4K=10,000 intermediate solutions per chunk, the 500 slowest ranks each get 10,000 intermediate solutions to evaluate, the 300 medium ranks each get 20,000 intermediate solutions to evaluate, and 100 fastest ranks each get 30,000 intermediate solutions to evaluate. These computations are massively parallel so the overall computing time should be equal to the time of the slowest/last rank to evaluate their solutions, i.e., ~10,000/100=100 seconds. If, in contrast, a purely balanced approach was used, where ranks received the same number of intermediate solutions (1.4M/1000 ranks=14,000 intermediate solutions for each rank) the computation time would be (14,000/100 per second=140 seconds).

In some examples, operations can be reordered within an expression evaluation. That is, each AI model/UDF rank can traverse an expression set (i.e., an expression tree) that needs to be evaluated for each potential solution in their subset of the global set of intermediate solutions (i.e., their local intermediate results). The expression tree can be reordered where possible without breaking conditional orders, or other operation constraints to optimize using greedy heuristics based on the time for each operation, and prioritizing the order of operations such that the fastest operations are performed first. If there are ties between operations' compute times (ties can be approximate and need not be exact ties) a tie is broken by choosing the operation that should eliminate the most solutions first. This is because reducing the subset of potential solutions more quickly will reduce the time needed for later operations. The number of solutions eliminated by an operation can be estimated using the profiling statistics (discussed above) for tracking how many times an AI model/UDF has been executed, and how many times an AI model/UDF has resulted in a solution being kept/retained for use.

This reordering can be performed on the basis of AI model/UDF rank so that each rank is independent of other ranks when deciding how to order the operations for their subset of the solutions being evaluated. This is possible since the expression evaluation is an independent evaluation. It is not until the ranks finish the evaluations on their subset that the ranks will sync solutions globally. This allows ranks to have different orderings to best suit the compute resources they are executing upon, which may differ (e.g., different GPUs or mix of CPUs/GPUs).

It should again be noted that such optimizations based upon AI model/UDF profiling statistics can be dynamic and can quickly change as users add new models with different behaviors, search different subgraphs of data with potentially different compute requirements, etc. Further still, it should be noted that users can mix/match multiple AI models and UDFs in the same query. Even incomplete data can be searched for using AI models that are capable of, e.g., searching images for “half” a toaster/cat/car. This type of search is not possible in traditional search manners, but is possible with AI models that can have varying confidence levels in their results.

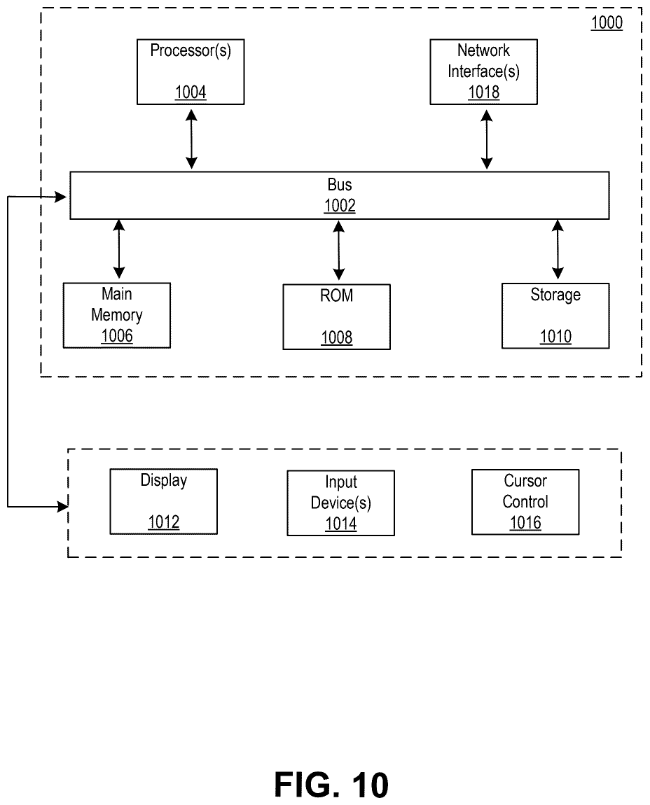

FIG. 10 depicts a block diagram of an example computer system 1000 in which various of the examples described herein may be implemented. The computer system 1000 includes a bus 1002 or other communication mechanism for communicating information, one or more hardware processors 1004 coupled with bus 1002 for processing information. Hardware processor(s) 1004 may be, for example, one or more general purpose microprocessors.

The computer system 1000 also includes a main memory 1006, such as a random access memory (RAM), cache and/or other dynamic storage devices, coupled to bus 1002 for storing information and instructions to be executed by processor 1004. Main memory 1006 also may be used for storing temporary variables or other intermediate information during execution of instructions to be executed by processor 1004. Such instructions, when stored in storage media accessible to processor 1004, render computer system 1000 into a special-purpose machine that is customized to perform the operations specified in the instructions.

The computer system 1000 further includes a read only memory (ROM) 1008 or other static storage device coupled to bus 1002 for storing static information and instructions for processor 1004. A storage device 1010, such as a magnetic disk, optical disk, or USB thumb drive (Flash drive), etc., is provided and coupled to bus 1002 for storing information and instructions.

The computer system 1000 may be coupled via bus 1002 to a display 1012, such as a liquid crystal display (LCD) (or touch screen), for displaying information to a computer user. An input device 1014, including alphanumeric and other keys, is coupled to bus 1002 for communicating information and command selections to processor 1004. Another type of user input device is cursor control 1016, such as a mouse, a trackball, or cursor direction keys for communicating direction information and command selections to processor 1004 and for controlling cursor movement on display 1012. In some examples, the same direction information and command selections as cursor control may be implemented via receiving touches on a touch screen without a cursor.

The computing system 1000 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 1000 may implement the techniques described herein using customized hard-wired logic, one or more ASICs or FPGAS, firmware and/or program logic which in combination with the computer system causes or programs computer system 1000 to be a special-purpose machine. According to one example, the techniques herein are performed by computer system 1000 in response to processor(s) 1004 executing one or more sequences of one or more instructions contained in main memory 1006. Such instructions may be read into main memory 1006 from another storage medium, such as storage device 1010. Execution of the sequences of instructions contained in main memory 1006 causes processor(s) 1006 to perform the process steps described herein. In alternative examples, hard-wired circuitry may be used in place of or in combination with software instructions.

The term “non-transitory media,” and similar terms, as used herein refers to any media that store data and/or instructions that cause a machine to operate in a specific fashion. Non-transitory media is distinct from but may be used in conjunction with transmission media. Transmission media participates in transferring information between non-transitory media.

The computer system 1000 also includes network interface 1018 coupled to bus 1002. Network interface 1018 provides a two-way data communication coupling to one or more network links that are connected to one or more local networks. In any such implementation, network interface 1018 sends and receives electrical, electromagnetic or optical signals that carry digital data streams representing various types of information.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed examples. The performance of certain of the operations or processes may be distributed among computer systems or computers processors, not only residing within a single machine, but deployed across a number of machines.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain examples include, while other examples do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

It should be noted that the terms “optimize,” “optimal” and the like as used herein can be used to mean making or achieving performance as effective or perfect as possible. However, as one of ordinary skill in the art reading this document will recognize, perfection cannot always be achieved. Accordingly, these terms can also encompass making or achieving performance as good or effective as possible or practical under the given circumstances, or making or achieving performance better than that which can be achieved with other settings or parameters.

1. A computing device comprising:
at least one processor; and
at least one memory unit comprising instructions that when executed, cause the at least one processor to:
store at an intelligent data store, data from a data source;
process the data to embed one or more artificial intelligence (AI) models in the intelligent data store;
index the data;
receive a query specifying at least one of a query operator, an AI model, and a user-defined function (UDF);
process the query by executing, in communication with an interface layer and multiple shards of the intelligent data store that have been automatically generated:
a query operator;
a UDF operator; and
an AI operator to evaluate data items stored in the multiple shards, wherein:
the query operator identifies data items satisfying a query-operator condition;
the UDF operator identifies, from the data items, data items satisfying a UDF condition; and
the AI operator applies the AI model as the one or more embedded AI models or via real-time query binding of the AI model to identify, from the data items, matching data items; and
return a result set in response to the query, wherein the data items identified by the query operator, the UDF operator, and the AI operator are merged into the result set.

2. The computing device of claim 1, wherein the instructions that when executed cause the at least one processor to process the data further comprise instructions that when executed, further cause the at least one processor to extract at least one of features and characteristics that are a part of or are associated with the data, and an object comprising the data.

3. The computing device of claim 2, wherein the instructions that when executed cause the at least one processor to process the data further comprise instructions that when executed, further cause the at least one processor to vectorize the data to generate one or more vector embeddings representative of the data.

4. The computing device of claim 3, wherein the instructions that when executed cause the at least one processor to process the data further comprise instructions that when executed, further cause the at least one processor to apply the one or more AI models to the data.

5. The computing device of claim 4, wherein the instructions that when executed cause the at least one processor to process the data further comprise instructions that when executed, further cause the at least one processor to incorporate at least one of inferences and predictions resulting from the application of the one or more AI models into the data.

6. The computing device of claim 5, wherein the instructions that when executed cause the at least one processor to index the data further comprise instructions that when executed, further cause the at least one processor to represent the data in a file structure.

7. The computing device of claim 6, wherein the file structure comprises the at least one of the extracted features and characteristics that are at least one of a part of and are associated with the data, and the object comprising the data.

8. The computing device of claim 6, wherein the indexing of the data facilitates searching for the at least one of the extracted features or characteristics that are at least one of a part of and are associated with the data, and the object comprising the data via the query.

9. The computing device of claim 6, wherein the indexing of the data facilitates searching for similarity determinations based on the one or more vector embeddings via the query.

10. The computing device of claim 6, wherein the at least one memory unit comprises further instructions, that when executed, further cause the processor to store the one or more AI models as part of the file structure.

11. The computing device of claim 1, wherein the query binding of the AI model comprises invoking the AI model using a bind function in the query that allows for creation of a new function by defining the AI model in real-time.

12. The computing device of claim 1, wherein the query binding of the UDF comprises invoking the UDF using a bind function in the query that allows for creation of a new function by defining the UDF in real-time.

13. The computing device of claim 1, wherein the instructions that when executed cause the at least one processor to process the query comprise further instructions that when executed, further cause the at least one processor to initiate searching of the data store via an interface layer implemented between a user computer and the intelligent data store.

14. The computing device of claim 13, wherein the searching of the intelligent data store comprises determining whether one or more items of the data satisfy or match a condition associated with at least one of the query operator, the AI model, and the UDF.

15. The computing device of claim 1, wherein the at least one memory unit comprises further instructions that when executed, further cause the at least one processor to store the result set in the intelligent data store to be returned in response to one or more future queries.

16. A computing device comprising:
at least one processor; and
at least one memory unit comprising instructions that when executed, cause the at least one processor to:
determine a rate of operations associated with a query expression for at least one or more artificial intelligence (AI) models or user-defined functions (UDFs) specified in the query expression;
determine a rate of operations across the at least one of the one or more AI models or UDFs;
determine per-rank rates of operations associated with the at least one of the one or more AI models or UDFs based on the determined rates of operations; and
redistribute intermediate solutions using the query expression across the at least one of the one or more AI models or UDFs based on the per-rank rates of operations associated with the at least one of the one or more ADI models or UDFs.

17. The computing device of claim 16, wherein the instructions that when executed cause the at least one processor to determine the rate of operations comprises further instructions that when executed, further cause the at least one processor to compute an average number of AI operations or UDFs performed per second for a given expression set based on times associated with ranks of AI models or UDFs.

18. The computing device of claim 16, wherein the at least one memory unit comprises further instructions that when executed, further cause the at least one processor to reorder operations while evaluating execution of the query expression.

19. A system, comprising:
a front end user interface receiving a user query to be executed;
one or more intelligent data stores comprising multiple shards that have been automatically generated from which data is obtained; and
one or more compute nodes operatively connected to the one or more intelligent data stores, the one or more compute nodes adapted to:
process the data by extracting features from the data, vectorizing the data, and embedding one or more artificial intelligence (AI) models in the one or more intelligent data stores;
index the data to facilitate at least one of searching and analysis of the data in accordance with the user query, the user query specifying at least one of a query operator, an AI model, and a user-defined function (UDF);
execute the query by executing, in communication with an interface layer and the multiple shards:
the query operator;
a UDF operator; and
an AI operator to evaluate data items stored in the multiple shards, wherein:
the query operator identifies data items satisfying a query-operator condition;
the UDF operator identifies, from the data items, data items satisfying a UDF condition; and
the AI operator applies the AI model as one of the one or more embedded AI models or via real-time query binding of the AI model to identify, from the data items, matching data items; and
merge the data items identified by the query operator, the UDF operator, and the AI operator into a result set to be returned in response to the query.

20. The system of claim 19, wherein the query binding of the AI model comprises invoking the AI model using a bind function in the query that allows for creation of a new function by defining the AI model in real-time.
